(19) United States
(12) Patent Application Publication
(10) Pub. No.: US 2017/0199973 A1
(43) Pub. Date: Jul. 13, 2017

(54) CAREGIVER COMMUNICATION DEVICE WITH CAREGIVER ACTIVE WORKSPACE FOR PATIENT CHARTING

(71) Applicant: Hill-Rom Services, Inc., Batesville, IN (US)

(72) Inventors: Kelly F. WALTON, Cary, NC (US); Kiana M. DEZELON, Cary, NC (US)

(21) Appl. No.: 15/398,822

(22) Filed: Jan. 5, 2017

Related U.S. Application Data
(60) Provisional application No. 62/275,828, filed on Jan. 7, 2016.

(51) Int. Cl. G06F 19/00

(52) U.S. Cl. CPC G06F 19/3418; G06F 19/3406; G06F 19/327; G06F 19/3425; G06F 19/322; H04L 63/08

(57) ABSTRACT

According to the present disclosure, a caregiver communication device includes a personal mobile device and a caregiver active workspace that includes a virtual workplace providing live access to shared data. The caregiver active workspace provides data sharing from multiple underlying architectures to accommodate caregiver and patient needs.

### CROSS-REFERENCE TO RELATED APPLICATIONS

This application claims priority to U.S. Provisional Application No. 62/275,828 filed Jan. 7, 2016, the disclosure of which is hereby expressly incorporated by reference in its entirety.

### BACKGROUND

The present disclosure relates to devices and systems for managing patient care. More specifically, devices and systems for charting patient information.

In a care facility, such as a hospital, caregivers are often assigned to multiple patients of the care facility and must manage a demanding schedule involving many types of tasks. Different patients may have different caregiver needs, such as different levels of monitoring, safety requirements, medication requirements, among others. Managing many patients having different needs can be particularly challenging while maintaining accurate and timely chart information for each patient and while coordinating with a team of caregivers.

### SUMMARY

The present application discloses one or more of the features recited in the appended claims and/or the following features which, alone or in any combination, may comprise patentable subject matter:

According to an aspect of the disclosure, a caregiver communication device may include a personal mobile device including a user interface, a caregiver active workspace configured to receive and display data entered via the user interface, and the caregiver active workspace may include a virtual workspace associated with at least one patient of a care facility and configured for live access by caregivers assigned to the at least one patient via the personal mobile device.

In some embodiments, the caregiver active workspace may be configured to receive user communications entered via the user interface for addition to the virtual workspace, and user communications include at least one of text messages and picture messages.

In some embodiments, the caregiver active workspace may be configured for selective access to the user communications on the virtual workspace via the user interface.

In some embodiments, the caregiver active workspace may be configured to communicate with a workflow management system configured to manage workflow within the care facility.

In some embodiments, the caregiver active workspace may be configured to receive and display workflow information from the workflow management system.

In some embodiments, the caregiver active workspace may be configured to receive workflow information updates entered via the user interface and to transmit the workflow information updates to the workflow management system.

In some embodiments, the caregiver active workspace may be configured for access to data of the care facility by selective configuration for at least one of a real-time, periodic, event-based, or query-based updating.

In some embodiments, the caregiver active workspace may be configured for access by caregivers assigned to the at least one patient via the personal mobile device upon authentication.

In some embodiments, the caregiver workspace may be configured to selectively communicate at least a portion of the virtual workspace to an electronic medical records database of the care facility.

In another aspect of the disclosure, a caregiver communication system may includes a first personal mobile device including a user interface, a second personal mobile device including a user interface, a caregiver active workspace configured to receive data entered via the user interfaces, and the caregiver active workspace includes a virtual workspace associated with at least one patient of a care facility and configured for live access by caregivers assigned to the at least one patient via the first and second personal mobile devices.

In some embodiments, the caregiver active workspace may be configured to receive user communications entered via either of the user interfaces for addition to the virtual workspace, and the user communications include at least one of text messages and picture messages.

In some embodiments, the caregiver active workspace may be configured for selective access to the user communications on the virtual workspace via each of the user interfaces.

In some embodiments, the caregiver active workspace may be configured to communicate with a workflow management system configured to manage workflow within the care facility.

In some embodiments, the caregiver active workspace may be configured to receive and display workflow information from the workflow management system.

In some embodiments, the caregiver active workspace may be configured to receive workflow information updates entered via either of the user interfaces and to transmit the workflow information updates to the workflow management system.

In some embodiments, the caregiver active workspace may be configured for access by caregivers assigned to the at least one patient via the personal mobile devices upon authentication.

In some embodiments, the caregiver active workspace may be configured for access by selective configuration of each of the personal mobile devices for at least one of a real-time, periodic, event-based, or query-based updating.

In some embodiments, the caregiver workspace may be configured to selectively communicate at least a portion of the virtual workspace to an electronic medical records database of the care facility.

In another aspect of the disclosure, a caregiver communication system of a care facility may include at least one personal mobile device including a user interface, a workflow system configured to communicate with a network of the care facility and configured to receive and send data entered via the user interface of the at least one mobile device to maintain a caregiver active workspace including a virtual workspace associated with at least one patient of the care facility, and the virtual workspace is configured for live access by caregivers assigned to the patient via the at least one personal mobile device.

In some embodiments, the virtual workspace may be a temporary workspace including data entered via the user interface of the at least one mobile device and accessible to other personal mobile devices upon authentication.

Additional features alone or in combination with any other feature(s), including those listed above and those listed in the claims and those described in detail below, can comprise patentable subject matter. Others will become apparent to those skilled in the art upon consideration of the following detailed description of illustrative embodiments exemplifying the best mode of carrying out the invention as presently perceived.

### BRIEF DESCRIPTION OF THE DRAWINGS

The detailed description particularly refers to the accompanying figures in which:

FIG. 1 is an diagram of a caregiver communication device including a personal mobile device and a caregiver active workspace that has a virtual workspace associated with at least one patient of a care facility and showing that the virtual workspace provides live access to caregivers assigned to the patient via the personal mobile device;

FIG. 2 is an illustrative depiction of the personal mobile device of the caregiver communication device shown in FIG. 1 showing that personal mobile device includes a user interface displaying an authentication prompt graphic;

FIG. 3 is an illustrative depiction of the personal mobile device of the caregiver communication device of FIGS. 1 and 2 showing a selectable list of patients assigned to the caregiver of the personal mobile device 12;

FIG. 4 is an illustrative depiction of the personal mobile device of the caregiver communication device of FIGS. 1 and 2 showing that the caregiver active workspace receives user communications entered on the user interface for addition to the virtual workspace, and showing that the caregiver active workspace provides selective access to the user communications on the virtual workspace via the user interface of the personal mobile device;

FIG. 5 is an illustrative depiction of the personal mobile device of the caregiver communication device of FIGS. 1 and 2 showing that the caregiver active workspace provides selective access to reminders associated with at least one patient of the care facility;

FIG. 6 is an illustrative depiction of the personal mobile device of the caregiver communication device of FIGS. 1 and 2 showing that the caregiver active workspace provides selective access to requests associated with at least one patient of the care facility;

FIG. 7 is an illustrative depiction of the personal mobile device of the caregiver communication device of FIGS. 1 and 2 showing that the caregiver active workspace provides selective access to safety information associated with at least one patient of the care facility;

FIG. 8 is an illustrative depiction of the personal mobile device of the caregiver communication device of FIGS. 1 and 2 showing that the caregiver active workspace provides selective access to particular information associated with at least one patient of the care facility;

FIG. 9 is an illustrative depiction of the personal mobile device of the caregiver communication device of FIGS. 1 and 2 showing that the caregiver active workspace provides selective access to a list of caregivers of the care facility and their relationship to at least one patient of the care facility;

FIG. 10 is an illustrative depiction of the personal mobile device of the caregiver communication device of FIGS. 1 and 2 showing that the caregiver active workspace provides selective access to history and statistics information associated with at least one patient of the care facility;

FIG. 11 is an illustrative depiction of the personal mobile device of the caregiver communication device of FIGS. 1 and 2 showing that the caregiver active workspace provides selective access to notification information associated with at least one caregiver of the care facility;

FIG. 12 is an illustrative depiction of the personal mobile device of the caregiver communication device of FIGS. 1 and 2 showing that the caregiver active workspace provides selective access to a list of staff of the care facility for communication therewith;

FIG. 13 is an illustrative depiction of the personal mobile device of the caregiver communication device of FIGS. 1 and 2 showing that the caregiver active workspace provides selective access to equipment information associated with at least one caregiver of the care facility;

FIG. 14 is an illustrative depiction of the personal mobile device of the caregiver communication device of FIGS. 1 and 2 showing that the caregiver active workspace provides selective access to statistical information associated with at least one caregiver of the care facility;

FIG. 15 is a flow diagram depicting an authorization process of the caregiver communication device;

FIG. 16 is a flow diagram of a process of updating a medical record system of the care facility.

### DETAILED DESCRIPTION OF THE DRAWINGS

Caregivers in a care facility, such as a hospital, for example, often work in groups to manage many patients of a care facility. According to the present disclosure, enabling data sharing between caregivers assists in managing and treating patients. The disclosure also addresses providing tailored data sharing platforms for sharing different types of data between caregivers to provide ease of communications and data sharing. In addition, the disclosure provides for caregivers having commonly assigned patients to easily and quickly share patient-related data, such as charting notes, by having access to a common data sharing platform.

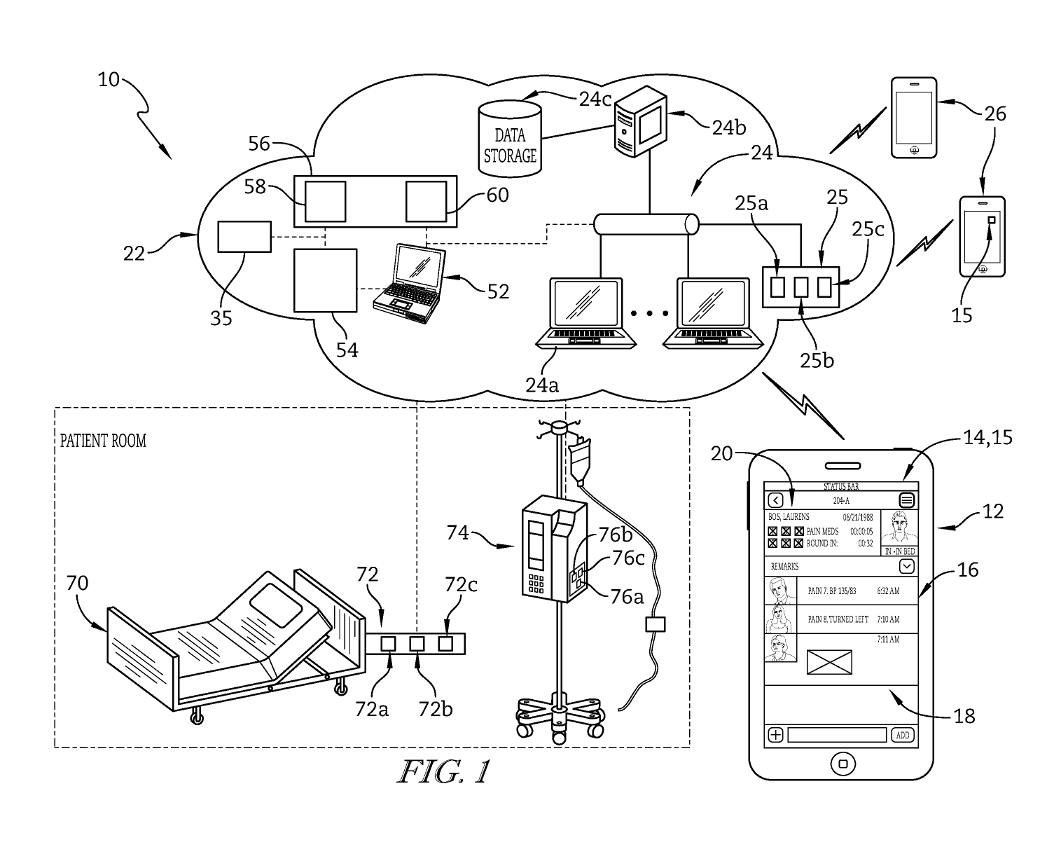

Specifically, a caregiver communication system 10 of a care facility includes a personal mobile device 12 and a caregiver active workspace 16 as shown in the illustrative embodiment of FIG. 1. Personal mobile device 12 illustratively includes a user interface 14 and software 15 configured to provide user access to caregiver active workspace 16 as a platform for access to shared data. The shared data accessible on the caregiver active workspace 16 illustratively includes data related to a patient (such as assigned caregivers, risk hazards, medication times, and identifying information, etc.), data related to a caregiver (such as messages, notifications, equipment, performance metrics, etc.), and/or data related to the care facility (equipment, staff, etc.).

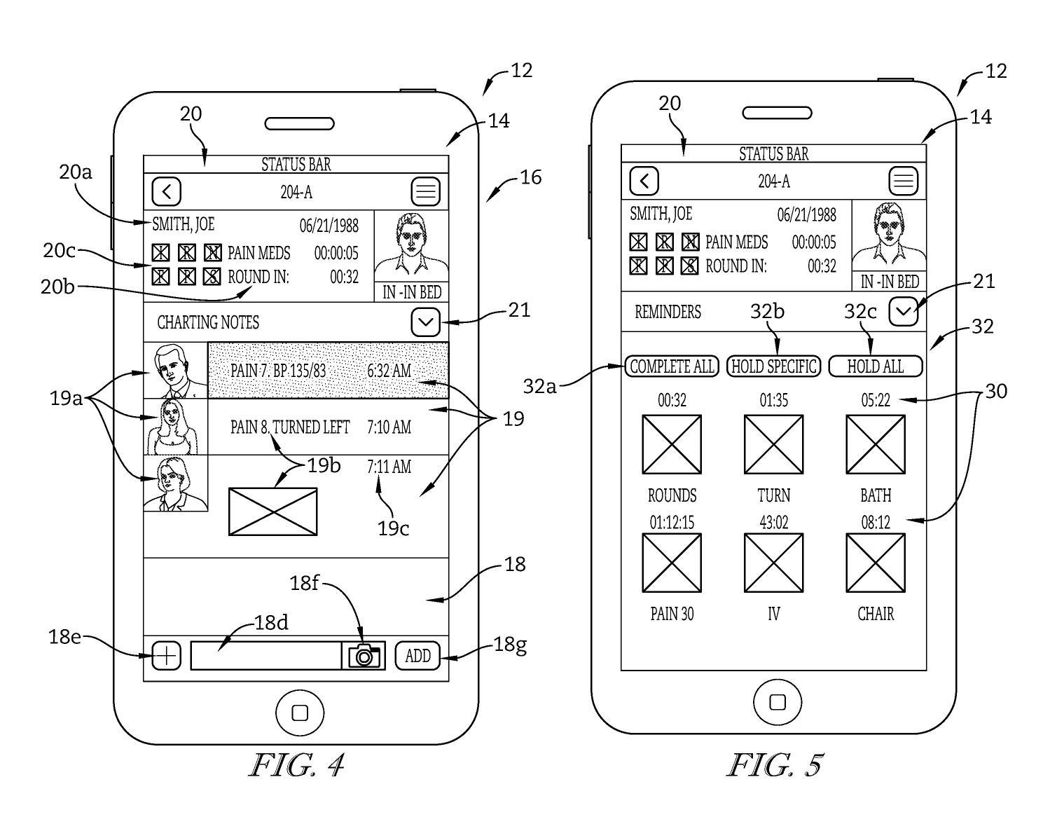

Caregiver active workspace 16 illustratively includes a virtual workspace 18 associated with specific patients of the care facility as shown in FIG. 1. Virtual workspace 18 is illustratively embodied as a virtual shared platform on which caregivers can access (including retrieve, review, share, enter, alter, manipulate, create, and/or remove) data regarding particular patients. For example, caregivers can enter user communications including text (including icons) and/or picture messages onto virtual workspace 18 for charting specific patients' progress and treatment as suggested in FIGS. 1 and 4. In the illustrative embodiment, caregivers assigned with the same patient can easily share certain data pertaining to that patient by live access to the virtual workspace 18.

In the illustrative embodiment, caregiver active workspace 16 is configured to provide live access to virtual workspace 18 to relevant users (authorized and assigned caregivers) for seamless data sharing. Live access is illustratively embodied as real-time data sharing, but in some embodiments may include data sharing by real-time, nearly real-time, effectively real-time, event-based, other types of actively updated data sharing, and/or combinations thereof to create seamless availability of data to authenticated devices. As discussed herein, by maintaining data of virtual workspace 18 mostly or entirely on a workflow system 24 of network 22, reliance on other systems of network 22 can be reduced in sharing data on virtual workspace 18 and availability of shared data can be increased. In contrast, some data on caregiver active workspace 16, but not included on virtual workspace 18, is illustratively embodied as being accessed via other systems of network 22, for example, an electronic medical records system (EMR) 35.

In the illustrative embodiment, virtual workspace 18 communicates at least some data to other systems of network 22, but under a controlled two-step approach. Caregiver active workspace 16 requires a caregiver to affirmatively activate the upload of data of virtual workspace 18 onto EMR 35. This two-step approach (entry and upload) permits caregivers to review and edit content before sending charting information from virtual workspace 18 to EMR 35 and permits caregivers to quickly chart information with less formality than would be desirable in the EMR 35 for later correction of such formalities. Virtual workspace 18 thus allows caregivers to quickly and easily share patient specific data, such as charting notes, with each other via their personal mobile devices 12, 26 in a virtual environment maintained and coordinated specifically for caregivers assigned to that patient and with controlled and/or limited dissemination into other systems of network 22.

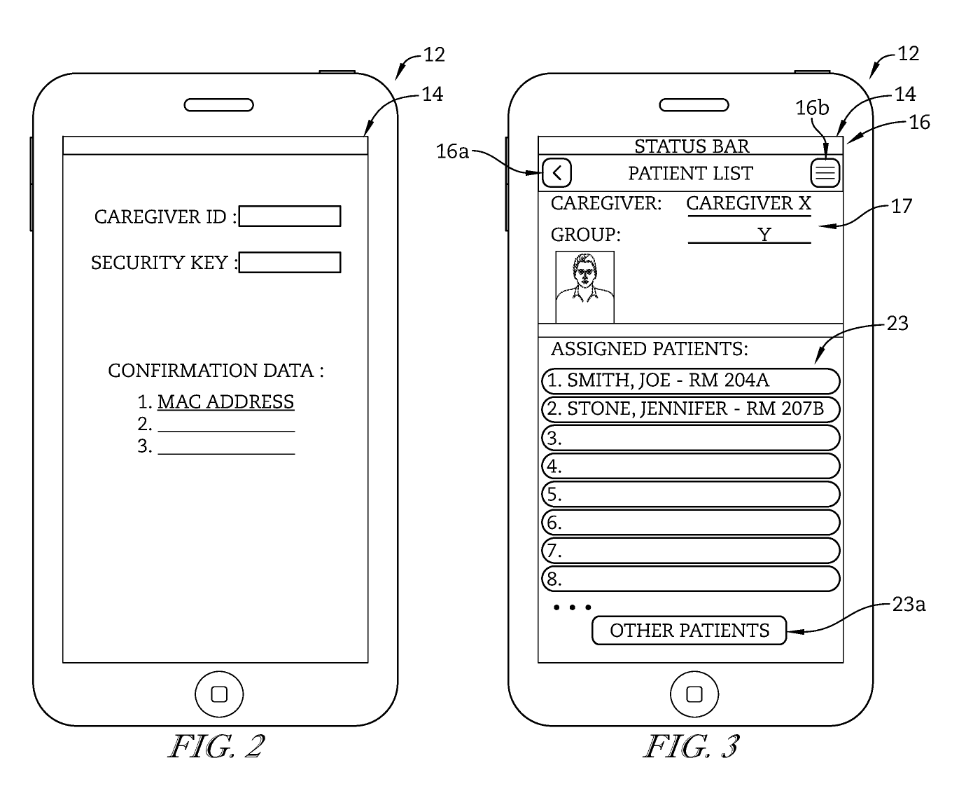

Personal mobile device 12 illustratively communicates with network 22 of the care facility to obtain access to caregiver active workspace 16 as shown in FIG. 1. In the illustrative embodiment, other personal mobile devices 26 of other caregivers communicate with network 22 to obtain access to caregiver active workspace 16. Other personal mobile devices 26 illustratively belong to other caregivers that are assigned to at least some patients not assigned to the caregiver of personal mobile device 12, but several caregivers have overlapping patient responsibility. The data available on caregiver active workspace 16 for a personal mobile device 12 will overlap with but will, in certain instances, be different from the data available to other personal mobile devices 26; for example, in instances where the data is caregiver-specific data, and in instances where the data is specific to a patient assigned to only one of the caregivers to whom personal mobile devices 12, 26 belong. Thus, the data accessed via caregiver active workspace 16 over a particular personal mobile device 12, 26 will correspond to the specific caregiver to whom the device 12, 26 belongs (and has been authenticated, as discussed herein regarding FIG. 2) and the patient assignments of that caregiver.

In this example, data of virtual workspace 18 for patients commonly assigned between the respective caregivers to whom the devices 12, 26 belong (and more specifically, the caregiver ID used for authentication) is automatically accessible on both personal mobile devices 12, 26. However, data of virtual workspace 18 for patients not assigned to a respective caregiver is illustratively not available via that caregivers devices 12, 26. In some embodiments, devices 12, 26 may be permitted to access data of patients not assigned to the particular caregiver via caregiver active workspace 16 but this may require additional specific configuration and/or search within caregiver active workspace 16. Personal mobile devices 12, 26 illustratively communicate with a workflow system 24 of the network 22 to access caregiver active workspace 16.

Network 22 includes workflow system 24 for communication with personal mobile devices 12, 26 as shown in FIG. 1. Workflow system 24 is a system of components and software configured for managing workflow information of the care facility including identifying, assigning, recording, managing, and executing tasks with respect to medical staff. In the illustrative embodiment, workflow information includes the information used to generate reminders, requests, history and status, equipment, and performance information screens, as discussed in detail below. In some embodiments, workflow information may include additional, fewer, and/or combinations of these types of information. An example of an acceptable workflow system is described in U.S. Pat. No. 7,796,045, the contents of which are incorporated by reference in their entirety, including at least the disclosed configurations of hardware, software, and control logic for identifying, assigning, recording, managing, and executing tasks with respect to medical staff. In the illustrative embodiment, workflow system 24 illustratively includes one or more workflow system terminals 24a, servers 24b, data storage devices 24c, and a communication module 25 for managing workflow information and caregiver active workspace 16.

Communication module 25 illustratively communicates with personal mobile devices 12, 26 as shown in FIG. 1. Communication module 25 includes a processor 25a configured to execute instructions stored on a memory device 25b, and to send and receive communication signals via a transceiver 25c. Communication module 25 provides communication between personal mobile devices 12, 26 and workflow system 24.

Workflow system 24 illustratively maintains shared data of the caregiver active workspace 16 and communicates with personal mobile devices 12, 26 to provide user access to caregiver active workspace 16. In the illustrative embodiment shown in FIG. 1, workflow system 24 is configured to store shared data, including workflow information, for the caregiver active workspace 16 on data storage devices 24c to provide access to authenticated personal mobile devices 12, 26. As shown in FIG. 2, access to caregiver active workspace 16 requires prior authentication by entry of a caregiver ID and a security key K, as discussed in detail below. In the illustrative embodiment, shared data of virtual workspace 18 is stored and maintained only on the workflow system 24 to provide the two-step charting approach mentioned above. Workflow system 24 thus provides a communication gateway for personal mobile devices 12, 26 to access caregiver active workspace 16 with live access to virtual workspace 18.

Caregiver active workspace 16 illustratively provides access to various data of care facility as shown in FIGS. 3-14. Upon proper authentication, caregiver active workspace 16 enables user selection of a specific patient from a patient list informational screen as shown in FIG. 3. Properly authenticated personal mobile device 12 illustratively displays caregiver identifying information 17 and a list of patients assigned to the caregiver 23 (“Caregiver X”). Caregiver active workspace 16 illustratively includes menu button 16a for navigation to other informational screens (discussed hereafter) and options button 16b for access to configurable options of caregiver active workspace 16. Each patient on the list 23 illustratively includes the assigned patient room number and is selectable to provide expanded information and options, including access to the virtual workspace 18 as suggested in FIG. 4.

Caregiver active workspace 16 includes live access to virtual workspace 18 including data, such as charting notes, associated with a specific patient as shown in FIG. 4. As illustratively shown in FIG. 4, multiple caregivers assigned to patient Joe Smith have entered charting notes 19 onto virtual workspace 18. Virtual workspace 18 illustratively displays each entered charting note 19 including a caregiver identification information 19a (caregiver photograph, icon, name, etc.), charting notes (text notes, picture notes, etc.) 19b, and the time of the entry 19c. Each entered charting note 19 is illustratively selectable to display expanded information and/or to permit direct communication with the note taker (i.e., the caregiver that entered the note). Data entered on virtual workspace 18 is stored and maintained for use by workflow system 24 to provide live access without querying other systems of network 22. In the illustrative embodiment, charting notes 19 that have been uploaded to the EMR 35 are indicated on virtual workspace 18 by dotted fill, but in some embodiments may be indicated by any of coloration, icon, and/or any other distinguishing means.

In the illustrative embodiment of FIG. 4, caregiver active workspace 16 includes access to general patient information 20 and virtual workspace 18 for charting the progress and treatment of an assigned patient. General patient information 20 illustratively includes patient identification information 20a (name, birthday, photograph, location [in room, in bed], room number, etc.), caregiver reminders 20b (medication, rounds, etc.), and patient risk factors 20c (isolation, fall, pulmonary, skin, restraint, etc.).

A caregiver can enter new charting notes for display on virtual workspace 18 as shown in the illustrative embodiment of FIG. 4. A caregiver can illustratively enter new text notes by selecting a text entry field 18d which prompts display of an electronic keyboard, can enter new pre-scripted text by selecting a pre-scripted text entry button 18e which prompts display of a number of predetermined textual notes for selection, and/or can enter new picture notes by selecting a photograph button 18f which prompts selection between existing photos and a new photo. Entry of picture notes illustratively accesses photos stored on personal mobile device 12 and a camera of personal mobile device 12. After input of the desired new charting notes, the caregiver can select an add button 18g to send the notes onto virtual workspace 18 for immediate sharing among assigned caregivers. Virtual workspace 18 thus enables live access to charting notes 19 for one and/or more caregivers associated with the particular patient.

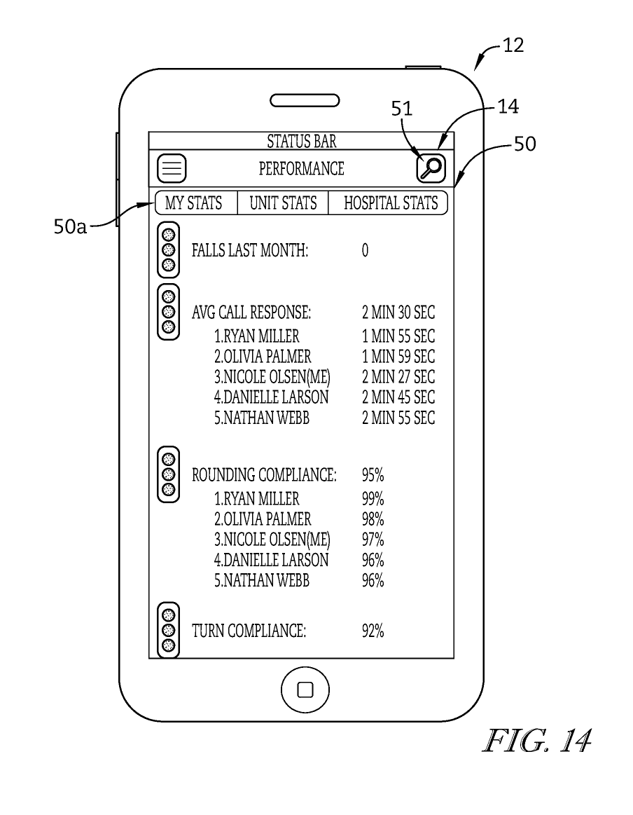

In the illustrative embodiment, access to caregiver active workspace 16 is secured by first requiring an authentication process as suggested in FIGS. 2 and 14. To obtain access to caregiver active workspace 16, a user, for example, a caretaker, executes pre-loaded software 15 on her personal mobile device 12 that prompts the user for authorization information including a unique caregiver ID and a security key K, each assigned by network 22, as shown in FIG. 2. As discussed in detail herein, upon correct entry of authorization information, personal mobile device 12 is configured for access to caregiver active workspace 16 according to the caregiver's assigned patients and duties as assigned by network 22. Other personal mobile devices 26 can also be configured for access to caregiver active workspace 16 by similar authentication and assignment by network 22. Once authenticated, personal mobile device 12 is configured to provide access to caregiver active workspace 16 as shown in FIGS. 3-14.

Caregiver active workspace 16 includes a menu button 21 for toggling the information accessed on caregiver active workspace 16 as shown in FIGS. 4-14. Menu button 21 prompts a list of informational screen selections of the caregiver active workspace 16 illustratively including the patient list (described above), reminders, requests, patient safety, particulars, caregivers list, history and status, notifications, staff list, equipment, user statistics as shown in FIGS. 3 and 5-14, respectively. In the illustrative embodiment, each of the reminders, requests, patient safety, particulars, caregivers list, and history and status informational screens generally provide patient specific information, while the notifications, staff list, equipment, and user statistics informational screen generally provide caregiver specific information, although combinations exist as described herein. Each informational screen provides access to certain information on caregiver active workspace 16.

In the illustrative embodiment shown in FIG. 5, the reminders informational screen provides access to various countdown timers 30 associated with a particular patient. Countdown timers 30 are each illustratively embodied as countdowns from periodic time intervals that provide reminders to caregivers that a patient requires a specific type of attention, the specific time intervals being based on the patient's needs and the type of attention. Countdown timers 30 illustratively include caregiver rounds, patient turn, patient baths, pain, IV, and chair timers, but in some embodiments may include any manner of pre-scripted and/or custom timers. Each countdown timer 30 is selectable to display an options list including individual timer options, for example, options to clear, reset, and/or manually enter a new countdown time. The reminders informational screen illustratively includes action buttons 32 including a complete all button 32a, a hold specific button 32b, hold all button 32c to enable simple and quick updating of the timers 30 by the user.

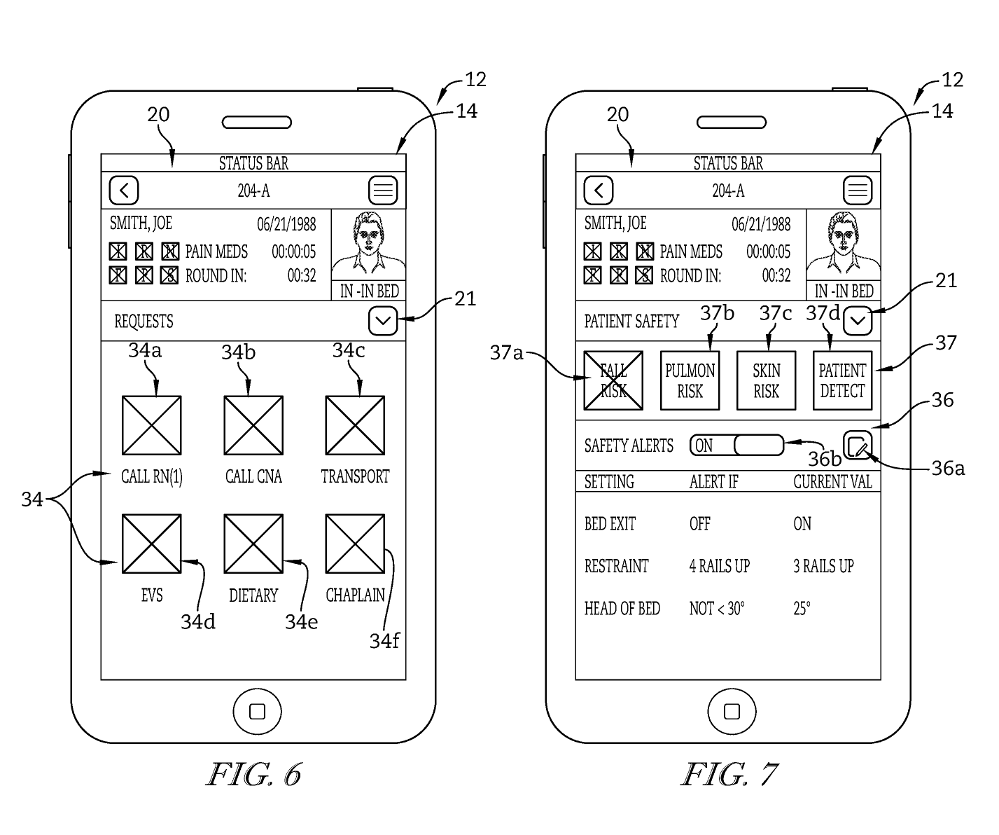

In the illustrative embodiment shown in FIG. 6, the requests informational screen provides access to various call buttons 34 associated with a particular patient. Calls buttons 34 are generally embodied to include requests for attention to a patient by a group responsible for a specific action and indicate pending unanswered calls to the user by displaying a number next to the button name, for example, “Call RN (1)” indicates that a one pending unanswered call for a registered nurse (RN) exists for the specific patient. As shown in FIG. 6, call buttons 34 illustratively include a registered nurse (RN) call button 34a, a certified nursing assistant (CNA) call button 34b, a transport button 34c, an environmental services (EVS) button 34d, a dietary button 34e, and a chaplain button 34f, but in some embodiments may include any number and manner of call buttons to place request for attention of an appropriate staff group. Call buttons 34 are illustratively configured to allow a user to select a specific call button 34 and to prompt the user with options, for example, options to place a new request and/or remove an existing request. In the illustrative embodiment, requests placed and/or altered on the requests informational screen are embodied to send a signal to network 22 to communicate with existing call systems thereof, for example, a nurse call system (not shown).

In the illustrative embodiment shown in FIG. 7, the patient safety informational screen provides access to various patient risk buttons 37 and various safety alert settings 36 associated with a particular patient. As shown in FIG. 7, patient risk buttons 37 represent patient risk designations that illustratively include fall risk button 37a, pulmonary risk button 37b, skin risk button 37c, and patient detection within the bed risk button 37d, but in some embodiments may include any number and/or manner of patient risk designation buttons. Each patient risk button 37 is selectable to display the safety alert settings 36 available to that risk designation. In the illustrative embodiment shown in FIG. 7, safety alert settings 36 includes an alert setting button 38a and an alert switch 38b that is toggle-able between an on position that creates an alert for assigned caregivers if a particular safety alert setting is violated, and an off position in which no alert is generated for the particular patient risk button 37.

In the illustrative embodiment shown in FIG. 7, fall risk button 37a has been selected (as indicated by the X on button 37a) and safety alerts 36 specific to fall risk button 37a are displayed on the user interface 14. Safety alerts 36 illustratively include the alert conditions, for example, bed exit alarm (Off), restraint (4 Rails Up), and bed head section angle (Not>30°); and the current value for each alert condition illustratively shown as bed exit alarm (On), restraint (3 Rails Up), and bed head section angle (25°). Alert settings button 38a is embodied as selectable to permit user activated adjustment of each alert condition. A user can thus review and adjust patient safety information via caregiver active workspace 16.

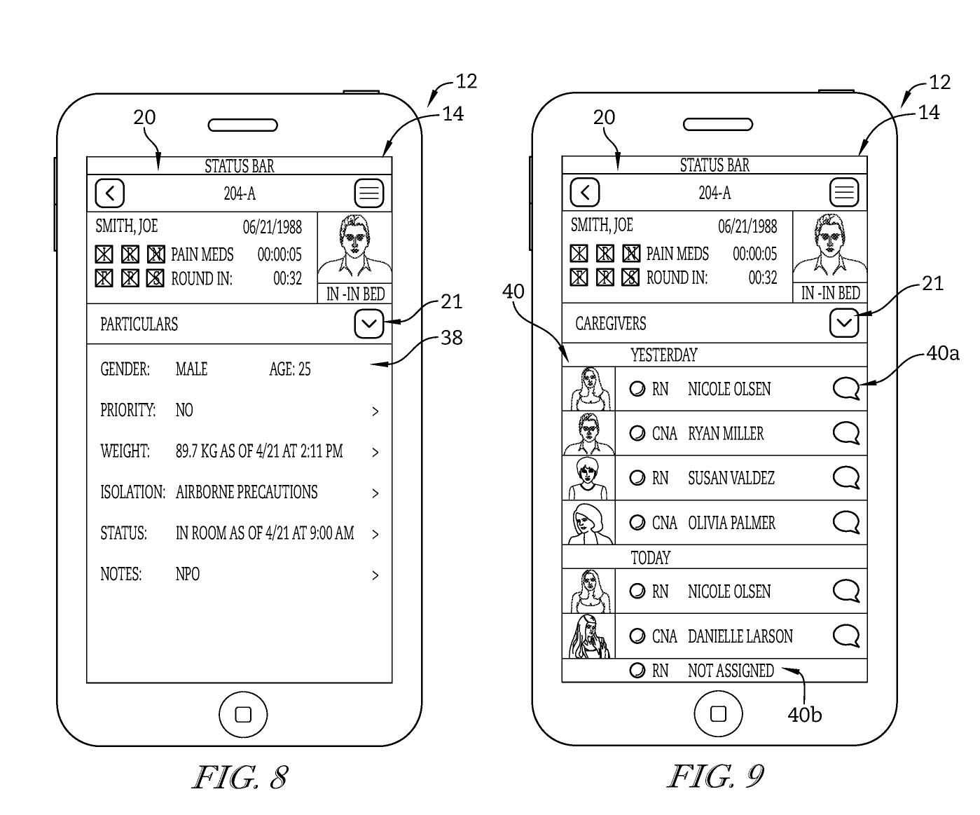

In the illustrative embodiment shown in FIG. 8, the patient particulars informational screen provides access to various detailed patient information 38 associated with a particular patient. Detailed patient information 38 illustratively includes gender, age, priority status, weight (including date and time of measurement), isolation status (for example, airborne precautions), location status (for example, whether within an assigned room, and the date and time of monitoring update), and notes (NPO). Certain detailed patient information 38 is illustratively selectable for additional detail as indicated by the “>” sign on the right hand side of user interface 14, for example, the notes detail is illustratively selectable to view additional textual characters.

In the illustrative embodiment shown in FIG. 9, the caregivers list informational screen provides access to a list of caregivers 40 recently associated with a particular patient. The list of caregivers 40 is illustratively organized by day, for example, yesterday's assigned caregivers are separated on another tab from today's caregivers, for ease of navigation as shown in FIG. 9. The list of caregivers includes a caregiver communications button 40a for each caregiver that is selectable to permit communication with the corresponding caregiver. In the illustrative embodiment, selection of a caregiver communications button 40a provides a text message interface, but in some embodiments may include any of text, picture, and/or voice communications. The list of caregivers 40 illustratively includes an unassigned caregiver button 40b that is selectable to provide a list of caregivers not otherwise displayed as caregivers recently assigned to the particular patient and including a caregiver communication button corresponding to each unassigned caregiver.

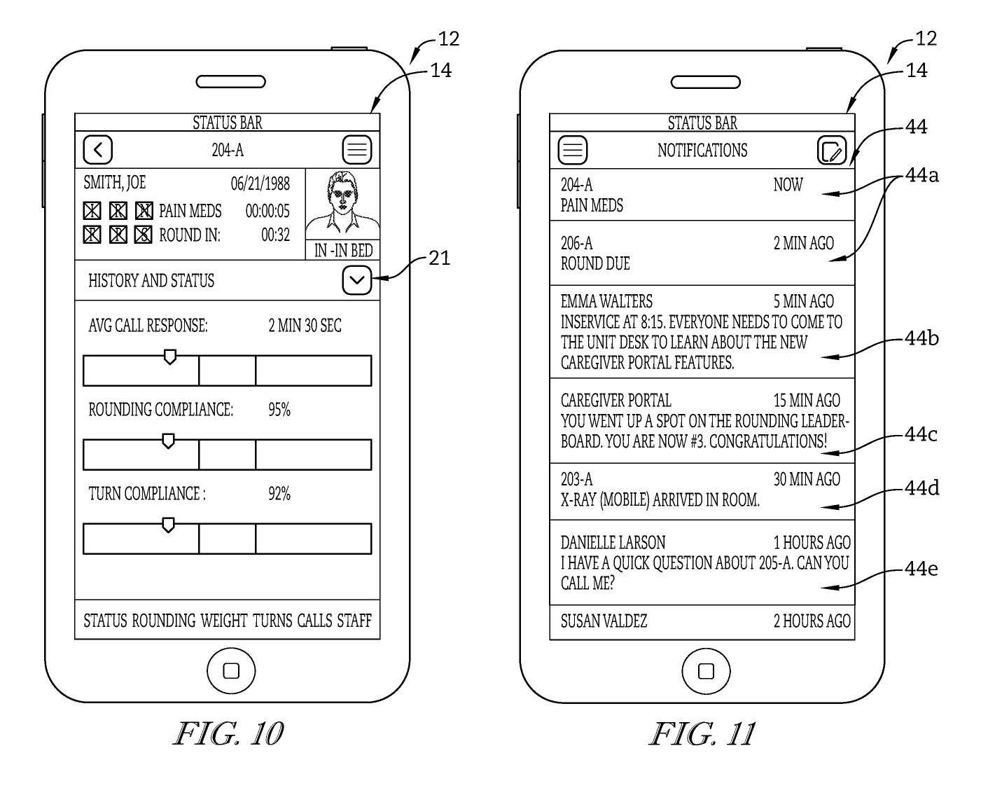

In the illustrative embodiment shown in FIG. 10, the history and status informational screen provides access to history and status information 42 regarding the responsiveness of the staff experienced by the patient. History and status information 42 illustratively includes metrics such as average call response time, rounding compliance, and turn compliance as experienced by the patient. In the illustrative embodiment, each metric includes a numerical and a graphic depiction (for example, a bar chart indicating the target metric range and the measure metric) of the information as suggested in FIG. 10.

In the illustrative embodiment shown in FIG. 11, the notifications informational screen provides access to various notifications 44 for the caregiver. Notifications 44 include various messages from other parts of network 22 and/or caregiver active workspace 16 including virtual workspace 18. Notifications 44 illustratively include countdown timer messages 44a (for example, those countdown timers 30 from the reminders informational screen shown in FIG. 5 which have reached a minimum threshold), global messages 44b generated for pre-determined groups of staff (for example, all caregivers), automated messages from caregiver monitoring systems 44c, call response messages 44d (for example, from calls accessible from the requests informational screen shown in FIG. 6 and/or equipment requests as discussed below), and direct caregiver messages 44e (for example, messages received from other caregivers over the caregivers list informational screen shown in FIG. 9).

In the illustrative embodiment shown in FIG. 12, the staff informational screen provides access to various staff information 46. Staff information 46 is illustratively organized by tabs 46a including all staff units, all staff in the unit of the caregiver authorized on the personal mobile device 12, and all staff currently on the shift in the unit of the caregiver authorized on the personal mobile device 12. Staff information 46 includes a list of the staff for each tab 46b with each staff member on the list including a photograph 46c, identifying information 46d (e.g., name, title, assignment-location, etc.), and a communication button 46e that is selectable for communications with the specific staff member (e.g., text, picture, and/or voice communications). Staff information 46 illustratively includes an alphabetical scroll bar 46f that is selectable to organize the staff members listed on a particular tab into alphabetical order and to quickly navigate to the general alphabetical portion of the list selected by the user. Staff information 46 illustratively includes a search button 47 for searching for staff members from a library of staff of the care facility.

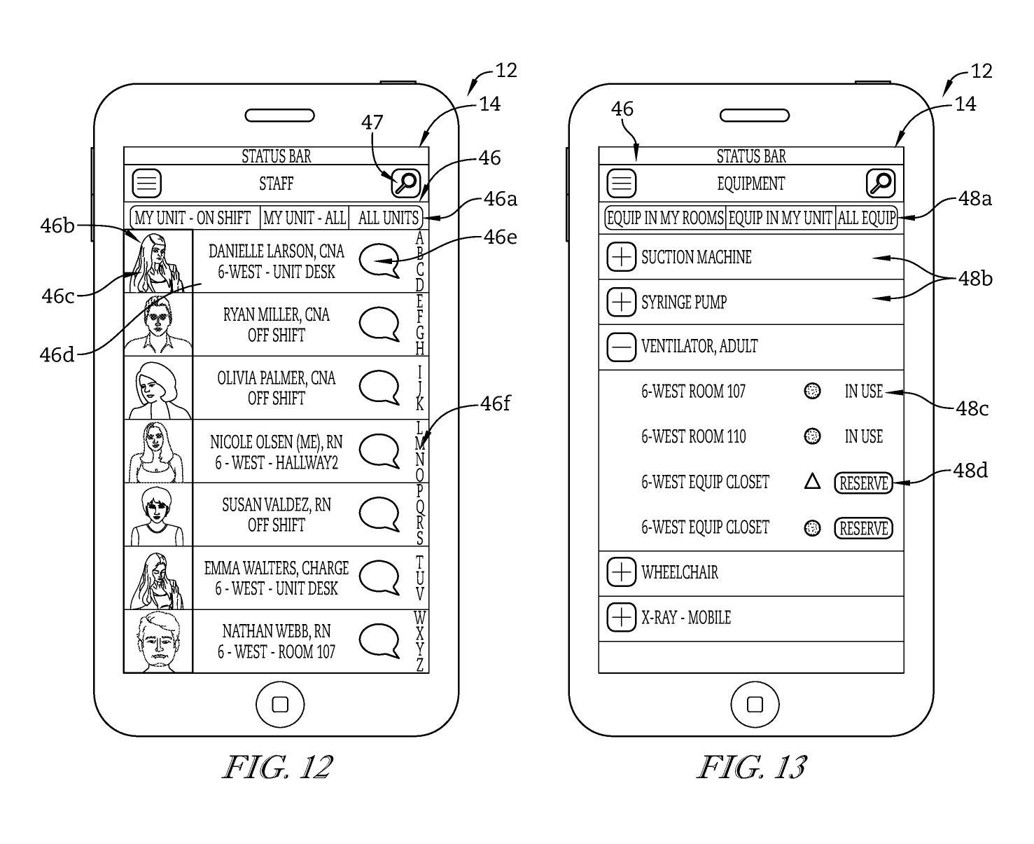

In the illustrative embodiment shown in FIG. 13, the equipment informational screen provides access to various equipment information 48. Equipment information is illustratively organized by tabs 48a including all equipment, equipment in the unit of the caregiver authorized on personal mobile device 12, and equipment within rooms assigned to the caregiver authorized on personal mobile device 12. Equipment information illustratively includes equipment type buttons 48b such as suction machine, syringe pump, ventilator (adult), wheelchair, x-ray (mobile), among others. Each equipment type button 48b is selectable to prompt a list of the individual pieces of equipment of that type including the location of each piece of equipment and an icon 48c, 48d indicating whether it is in use or can be reserved. If an individual piece of equipment is not in use, reserve button 48d is displayed and is selectable by the user to reserve the equipment. If another staff member is responsible to delivery specific equipment, for example, mobile x-ray equipment, selection of the reserve button illustratively also generates a request for such delivery.

In the illustrative embodiment shown in FIG. 14, the performance informational screen provides access to various performance metrics 50 of the caregiver authorized on the personal mobile device 12. Performance metrics 50 are illustratively organized by tabs including my stats (statistics representing the caregiver authorized on personal mobile device 12), unit stats (statistics representing all caregivers assigned to the unit of the authorized caregiver), and hospital stats (statistics representing all caregivers in the hospital). In the illustrative embodiment shown in FIG. 14, under the unit stats tab, performance metrics 50 include falls (e.g., the number of falls recorded for patients in the previous month), average response time (e.g., time elapsed from a patient or other call as an average for the unit and as an average for individuals in the unit over a predetermined period of time, for example, month to date), rounding compliance (e.g., percentage of required rounds completed within predetermined time intervals as an average for the unit and as an average for individuals in the unit over a predetermined period of time, for example, month to date), and turn compliance (e.g., percentage of required patient body repositioning completed within predetermined time intervals as an average for the unit and as an average for individuals in the unit over a predetermined period of time, for example, month to date). Performance metrics 50 include a search button 51 for searching for staff members from a library of staff of the care facility.

As mentioned above, access to caregiver active workspace 16 on personal mobile device 12 requires authentication by prompting the user for authentication information including a security key K and a caregiver ID as illustratively shown in FIG. 2. The caregiver ID is a unique identification code stored and associated with the caregiver in the relational database 54. The security key K is a unique authentication code illustratively generated by network 22. In the illustrative embodiment, network 22 includes a security key generator 56 configured to generate security key K.

As shown in FIG. 1, security key generator 56 illustratively includes a processor 58 and a memory device 60 storing instructions that, when executed by processor 58, generate security key K. In the illustrative embodiment, security key generator 56 includes dedicated hardware and software components. In some embodiments, one or more hardware and/or software components of the security key generator 56 may be combined hardware or software components of network 22. Once generated, security key K is illustratively stored in memory device 60 and is available to a caregiver on a master interface 52 of network 22. In some embodiments, the security key K may be generated by the security key generator 56 based on the caregiver ID and stored and associated with the caregiver in relational database 54 such that each caregiver has a unique security key K, providing an additional layer of security.

A caregiver can view and or otherwise obtain the security key K on the master interface 52. The caregiver can input an entered security key K_{E} and the caregiver ID into the prompt from the caregiver active workspace as shown in FIG. 2. Personal mobile device 12 illustratively sends an authentication request including the entered security key K_{E}, the entered caregiver ID, and the media access control (MAC) address of personal mobile device 12 to network 22, as authentication information. In some embodiments, personal mobile device 12 may send other information to network 22, for example, the IP address of personal mobile device 12. Network 22 receives the authentication request and compares the received information to the stored information. In the illustrative embodiment, network operation are embodied as performed by communication module 25 but in some embodiments may be performed by communication module 24, a dedicated network device, a shared network device, and/or combinations thereof.

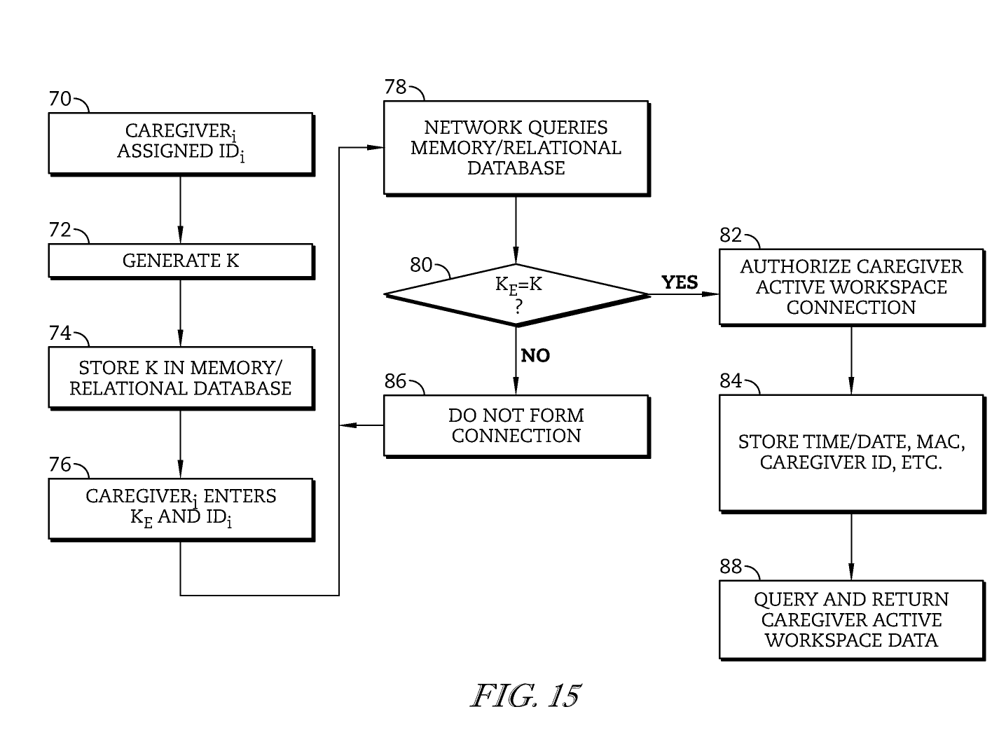

An authentication process is described below according to the illustrative embodiment shown in FIG. 15. As illustratively shown in steps 70-74 of the process flow diagram of FIG. 15, a caregiver is assigned a caregiver ID, security key generator 56 generates a security key K and stores the security key K in memory device 60. As illustratively shown in steps 76-88 of FIG. 15, network 22 performs validation of the entered security key K_{E} by prompting user input, querying security key generator 56 to retrieve the security key K, and comparing the retrieved security key K with an entered security key K_{E}.

As suggested in steps 80, 82, and 88 of FIG. 15, if the entered security key K_{E} matches the retrieved security key K, network 22 is configured to permit connection of personal mobile device 12 to access the caregiver active workspace 16. Connection of personal mobile device 12 to access the caregiver active workspace 16 is illustratively embodied as configuring the communication module 25 to allow one or more of access, retrieval, control, and/or modification of data on the workflow system 24. In step 88, information stored on network 22 that is not currently available on workflow system 24 is queried and sent to workflow system 24 for use on the caregiver active workspace 16, for example, if upon authentication of a new caregiver and/or a new patient is added to the caregiver active workspace 16 (e.g., that patient was not assigned to any caregiver already actively authenticated), then communication module queries other systems of network 22 to retrieve the required information (e.g., relational database 54, EMR 35, etc.). As illustrated in step 84, network 22 stores the validation information and the date and time of the authentication request.

In steps 80 and 86, if network 22 determines that the entered security key K_{E} does not match the retrieved security key K, network 22 illustratively communicates to the communication module 25 not to allow connection of personal mobile device 12 to the caregiver active workspace 16. Network 22 is illustratively configured to store the date and time of any failed attempts and to lockout the validation process for a given patient if the number of failed attempts exceeds a predetermined threshold within a predetermined time interval. An administrator can remove the lockout via master interface 52.

As mentioned above, in the illustrative embodiment as shown in FIG. 1, data storage devices 24c of workflow system 24 are configured to store and maintain shared data for access on the caregiver active workspace 16. In the illustrative embodiment, data of virtual workspace 18 and workflow information is stored and maintained on workflow system 24 to provide access thereto. In the illustrative embodiment, data of caregiver active workspace 16 not described as part of the virtual workspace 18 or as workflow information is temporarily stored and accessed on the workflow system 24 but is stored and maintained in other systems of network 22 such as the EMR 35 and the relational database 54. Thus, the operations described regarding the patient safety, particulars, caregivers list, notifications, and staff informational screens shown in FIGS. 7-9, 11, and 12 are executed on workflow system 24 to provide access via the caregiver active workspace 16 but the master data control lies in other systems of network 22 and is queried, retrieved, and/or pushed according to a data management scheme by workflow system 24 from those systems of network 22. Thus, the workflow system 24 illustratively communicates with existing systems of network 22 to perform the operations described regarding the informational screens shown in FIGS. 5-14, not including the functions of virtual workspace 18.

For example, patient safety information of the patient safety information screen, such as patient risk designations and safety alerts settings 36, is illustratively embodied as information accessible through the caregiver active workspace 16 but maintained through existing systems of network 22. In the illustrative embodiment, workflow system 24 queries and retrieves patient risk designations for a patient and stores the retrieved patient risk designations for access on caregiver active workspace 16 without having to query EMR 35 for each communication. In the exemplary instance, EMR 35 maintains and stores patient risk designations and workflow system 24 communicates with EMR 35 to retrieve, update, and/or manipulate the patient risk designations on the EMR 35 according to a data management scheme. Workflow system 24 illustratively communicates with EMR 35 to maintain updated data in each system according to predetermined and configurable data management scheme, for example, on a periodic basis. Thus, in the illustrative embodiment, other systems of network 22 illustratively access patient risk designations from EMR 35, and not directly from caregiver active workspace 16. In some embodiments, caregiver active workspace 16 may communicate directly, indirectly, and/or combinations thereof to provide and/or receive updates from various other systems of network 22 on a real-time, quasi-real time, periodic basis, event-oriented basis, and/or combinations thereof.

In the illustrative embodiment, shared data of virtual workspace 18 is stored and maintained on workflow system 24 as shown in FIG. 1. Communication module 25 provides communication between workflow system 24 and personal mobile devices 12, 26 (after authentication) enabling live access to virtual workspace 18. Data (such as charting notes) that is entered by a user onto virtual workspace 18 is received, stored and maintained, and communicated to other authorized personal mobile devices 26 by the workflow system 24. In the illustrative embodiment, each authenticated personal mobile device 12, 26 belongs to a single caregiver (and that has used her caregiver ID for authentication) and provides access to a unique virtual workspace 18 for each patient to which the single caregiver is assigned by network 22. In some embodiments, authenticated personal mobile devices 12, 26 may have access to virtual workspaces 18 for all patients of the care facility, but caregiver active workspace 16 may organize those virtual workspaces 18 associated with patients assigned to the caregiver authenticated on the device 12, 26 by tabs for easy access, while permitting a search and/or list function for patients not assigned to the caregiver.

In the illustrative embodiment, caregiver active workspace 16 provides access through workflow system 24 to data of virtual workspace 18, workflow information, and other data of caregiver active workspace 16. Data of virtual workspace 18 and workflow information are illustratively stored and maintained primarily on the workflow system 24 while remaining data of caregiver active workspace 16 is temporarily stored on workflow system 24 but is primarily stored and maintained on other systems of network 22. This arrangement provides various levels of information access through the caregiver active workspace 16 to accommodate the demands of the caregivers, for example, this permits live access to virtual workspace 18 without requiring such substantial access to other data of caregiver active workspace 16. In some embodiments, the storage and maintenance architecture may be intermixed between workflow system 24 and other systems of network 22 and/or may be configurable and/or or customizable on workflow system 24 and network 22 to provide live access to data as desired.

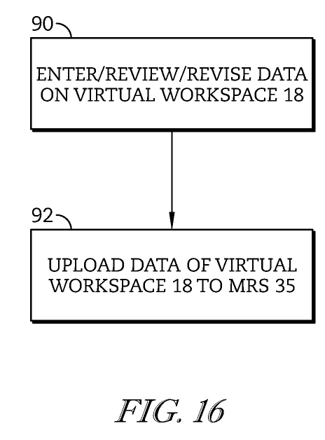

As mentioned above, data of virtual workspace 18 is uploaded onto EMR 35 as shown in the flow diagram of FIG. 16. In the illustrative embodiment, data of virtual workspace 18 is uploaded onto EMR 35 by a two-step approach. In step 90, assigned caregivers chart and edit patient notes onto virtual workspace 18 via their personal mobile devices 12, 26, for example, entering, reviewing, and/or revising data. In step 92, at least assigned caregiver uploads data for a particular patient from virtual workspace 18 onto EMR 35. Virtual workspace 18 thus provides a temporary workspace for charting patient notes, independent of other systems of network 22, before upload to EMR 35. The two-step updating of charting notes onto EMR 35 permits less formal and easy data sharing on virtual workspace 18 while maintaining charting notes and enabling seamless data sharing. In some embodiments, caregiver active workspace 16 may be selectively configurable for automatic uploading of at least some data from virtual workspace 18 onto EMR 35. In some embodiments, data (such as charting notes) entered onto personal mobile devices 12, 26 may be communicated directly to personal mobile devices 12, 26 of caregivers assigned to the same patient by direct communications, for example, through direct wireless transmission between personal mobile devices 12, 26 and may be separately communicated to workflow system 24 simultaneously and/or at a different time.

Returning to the illustrative embodiment shown in FIG. 1, a patient support device 71, illustratively embodied as a bed, and care device 74, illustratively embodiment as an IV pump, are located within a room of the care facility. Bed 71 illustratively includes a communication module 72 having a processor 72a, memory device 72b, and transceiver 72c. Care device 74 illustratively includes a communication module 77 having a processor 77a, memory device 77b, and transceiver 77c. Each of bed 71 and care device 74 are configured to communicate operational data with network 22 for use in various network systems including workflow system 24 and caregiver active workspace 16.

In the illustrative embodiment, an administrator of network 22 assigns patients to one or more caregivers. Such assignment includes associating at least one caregiver with at least one patient by configuration of network 22. In the illustrative embodiment, the manner for association of a caretaker with a patient is embodied as configuration of relational database 54 of network 22. Relational database 54 is illustratively embodied as a structured query language (SQL) database that includes attributes for association with each other, for example, bed 71, a patient, a caretaker, the MAC address of personal mobile device 12, among other things. Relational database 54 illustratively relates unique identification codes for each attribute and provides query responsive association of the identification codes to various systems within and outside of network 22, including workflow system 24. An exemplary use of a relational database is discussed within U.S. Patent Application Publication No. 2012/0316892, the contents of which are hereby incorporated by reference in their entirety, and at least including the arrangement, structure, and function of the relational database and auxiliaries. In illustrative embodiments, the manner of association of a caretaker to a patient is through the relational database 54 but in other embodiments may the manner of association may include any known manner for relation of information.

As shown in FIG. 1, personal mobile devices 12, 26 are illustratively embodied as a personal smartphone including software 15. Software 15 can be downloaded by a user (caregiver) to her personal mobile device 12, 26 from either a dedicated website and/or a third-party application marketplace, such as i-Tunes® or Google Play®, for example. When a user activates the software 15 on her personal mobile device 12, 26, the user is prompted for a security key K, as illustrated in FIG. 2. Software 15 is illustratively embodied as a mobile application downloaded and installed onto personal mobile devices 12, 26. In some embodiments, software 15 may include software for generating an authentication code based on the security key K, for example a multi-factor authentication such as RSA SecurID available from RSA Security LLC of Bedford, Mass.

Illustratively, authentication of personal mobile devices 12, 26 are maintained and a generated security key K remains valid until terminated via network 22. In some embodiments, security keys K may timeout after a predetermined duration that is configurable on network 22. In some embodiments, an administrator may elect to manually reset security keys K and terminate existing authentications by configuration of network 22 via master interface 52.

In the illustrative embodiment, communications between personal mobile devices 12, 16 and network 22 are embodied as performed by a Bluetooth® wireless protocol. In some embodiments, communications between personal mobile devices 12, 16 and network 22 may include any type of wireless protocol such as Wi-Fi (IEEE 802.11b/g/n), WiMax (IEEE 802.16e), Zigbee (e.g., 802.15.4), mobile communications technologies such as 3G or 4G technology, radio frequency (RF), and or other wireless protocols. In some embodiments, proximity limitations may be enforced by configuration of the communication module 25 to support only a limited range of communication, for example, by signal strength. In some embodiments, no proximity limitations may exist. In some embodiments, authentication may have proximity limitations for conducting authentication, as described above, but once authenticated proximity limitations may not exist. In some embodiments, proximity limitations may be configurable on-and-off by an administrator on network 22 via master interface 52.

Personal mobile devices 12, 26 are illustratively embodied as an iPhone available from Apple Inc. of Cupertino, Calif. In some embodiments, personal mobile devices 12, 26 may be any wireless communications device, for example, cellular telephones, smartphones, wireless telephone handsets, personal data assistants, personal computers (e.g., laptop, desktop, tablet), wearable computing devices (e.g., Google Glass available from Google Inc. of Mountain View, Calif.; Apple Watch available from Apple Inc. of Cupertino, Calif.).

Communications between personal mobile devices 12, 26 and network 22 may be secured and/or encrypted in any known manner. Any and/or all communication connections may be partly or wholly wired with either permanent and/or detachable connections, and may also comprise wireless communication, or any combination of wiring and wireless configurations.

Although certain illustrative embodiments have been described in detail above, variations and modifications exist within the scope and spirit of this disclosure as described and as defined in the following claims.

1. A caregiver communication device, comprising:
a personal mobile device including a user interface,
a caregiver active workspace configured to receive and share data entered via the user interface,
wherein the caregiver active workspace includes a virtual workspace associated with at least one patient of a care facility and configured for live access by caregivers assigned to the at least one patient via the personal mobile device.

2. The caregiver communications device of claim 1, wherein the caregiver active workspace is configured to receive user communications entered via the user interface for addition to the virtual workspace, and user communications include at least one of text messages and picture messages.

3. The caregiver communications device of claim 2, wherein the caregiver active workspace is configured for selective access to the user communications on the virtual workspace via the user interface.

4. The caregiver communication device of claim 1, wherein the caregiver active workspace is configured to communicate with a workflow management system that is configured to manage workflow within the care facility.

5. The caregiver communications device of claim 4, wherein the caregiver active workspace is configured to receive and share workflow information from the workflow management system.

6. The caregiver communications device of claim 5, wherein the caregiver active workspace is configured to receive workflow information updates entered via the user interface and to implement the workflow information updates on the workflow management system.

7. The caregiver communications device of claim 6, wherein the caregiver active workspace is configured for access to data of the care facility by selective configuration for at least one of a real-time, periodic, event-based, or query-based updating.

8. The caregiver communications device of claim 1, wherein the caregiver active workspace is configured for access by caregivers assigned to the at least one patient via the personal mobile device upon authentication.

9. The caregiver communications device of claim 1, wherein the caregiver workspace is configured to selectively upload at least a portion of the virtual workspace to an electronic medical records database of the care facility.

10. A caregiver communication system, comprising:
a first personal mobile device including a user interface,
a second personal mobile device including a user interface,
a caregiver active workspace configured to receive and share data entered via the user interfaces,
wherein the caregiver active workspace includes a virtual workspace associated with at least one patient of a care facility and configured for live access by caregivers assigned to the at least one patient via the first and second personal mobile devices.

11. The caregiver communications device of claim 10, wherein the caregiver active workspace is configured to receive and share user communications entered via either of the user interfaces onto to the virtual workspace, and the user communications include at least one of text messages and picture messages.

12. The caregiver communications device of claim 11, wherein the caregiver active workspace is configured for selective access to the user communications on the virtual workspace via each of the user interfaces.

13. The caregiver communication device of claim 10, wherein the caregiver active workspace is configured to communicate with a workflow management system that is configured to manage workflow within the care facility.

14. The caregiver communications device of claim 4, wherein the caregiver active workspace is configured to receive and display workflow information from the workflow management system.

15. The caregiver communications device of claim 5, wherein the caregiver active workspace is configured to receive workflow information updates entered via either of the user interfaces and to implement the workflow information updates on the workflow management system.

16. The caregiver communications device of claim 1, wherein the caregiver active workspace is configured for access by caregivers assigned to the at least one patient via the personal mobile devices upon authentication.

17. The caregiver communications device of claim 1, wherein the caregiver active workspace is configured for access by selective configuration of each of the personal mobile devices for at least one of a real-time, periodic, event-based, or query-based updating.

18. The caregiver communications device of claim 1, wherein the caregiver workspace is configured to selectively communicate at least a portion of the virtual workspace to an electronic medical records database of the care facility.

19. A caregiver communication system of a care facility, comprising:
at least one personal mobile device including a user interface,
a workflow system configured to communicate with a network of the care facility and configured to receive and share data entered via the user interface of the at least one mobile device to maintain a caregiver active workspace including a virtual workspace associated with at least one patient of the care facility,
wherein the virtual workspace is configured for live access by caregivers assigned to the patient via the at least one personal mobile device.

20. The caregiver communications device of claim 19, wherein the virtual workspace is a temporary workspace including data entered via the user interface of the at least one mobile device and accessible to other personal mobile devices upon authentication.
